(19) United States
(12) Patent Application Publication
(10) Pub. No.: US 2012/0181736 A1
(43) Pub. Date: Jul. 19, 2012

(54) MOUNTING APPARATUS FOR ELECTRONIC DEVICES

(75) Inventors: MENG-BIN YU, Wuhan City (CN); MING-HUI LUO, Wuhan City (CN); CONG-XU HU, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/278,455

(22) Filed: Oct. 21, 2011

(30) Foreign Application Priority Data
Jan. 14, 2011 (CN) 201110007617.2

(51) Int. Cl. B25B 11/00

(52) U.S. Cl. 269/91

(57) ABSTRACT

A mounting apparatus for securing electronic devices is disclosed. The mounting apparatus comprises a base; two supports secured to the base; a positioning member located in each of the two supports, wherein the positioning member and each of the two supports are configured to move relative to each other along an axis parallel to a surface of the base, and the positioning member has a tooth-faced side with a plurality of first teeth; a securing member having a plurality of second teeth, wherein the securing member is adapted to engage with the positioning member by meshing the plurality of second teeth and the plurality of first teeth, and the securing member is slidable towards the base along the position member; and two resilient members located in each of the two supports, wherein the two resilient members maintains engagement between the plurality of first teeth and the plurality of second teeth.

### BACKGROUND

1. Technical Field

The present disclosure relates to mounting apparatuses, and particularly to a mounting apparatus for securing electronic devices.

2. Description of Related Art

Electronic devices should be tested to ensure capability and quality before being sold. The electronic devices are typically mounted to a test apparatus in testing by screws, which processes are very time-consuming and inconvenient. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and an electronic device in accordance with an embodiment.

FIG. 2 is an enlarged view of a circled portion II in FIG. 1.

FIG. 3 is an assembled view of the mounting apparatus with the electronic device according to one embodiment.

FIG. 4 is a cross-sectional view taken along the line IV-IV in FIG. 3, (the electronic device is not shown).

FIG. 5 is an enlarged view of the circled portion V in FIG. 4.

FIG. 6 is another assembled view of the mounting apparatus without the electronic device.

FIG. 7 is a cross-sectional view taken along the line VII-VII in FIG. 6.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

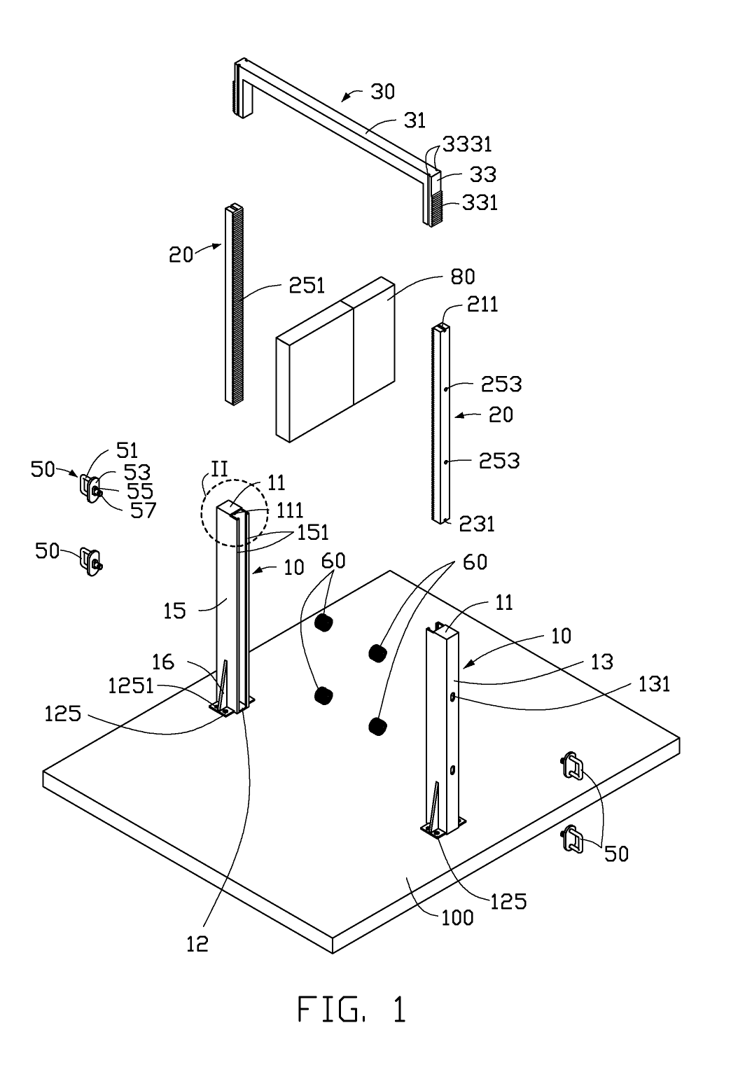

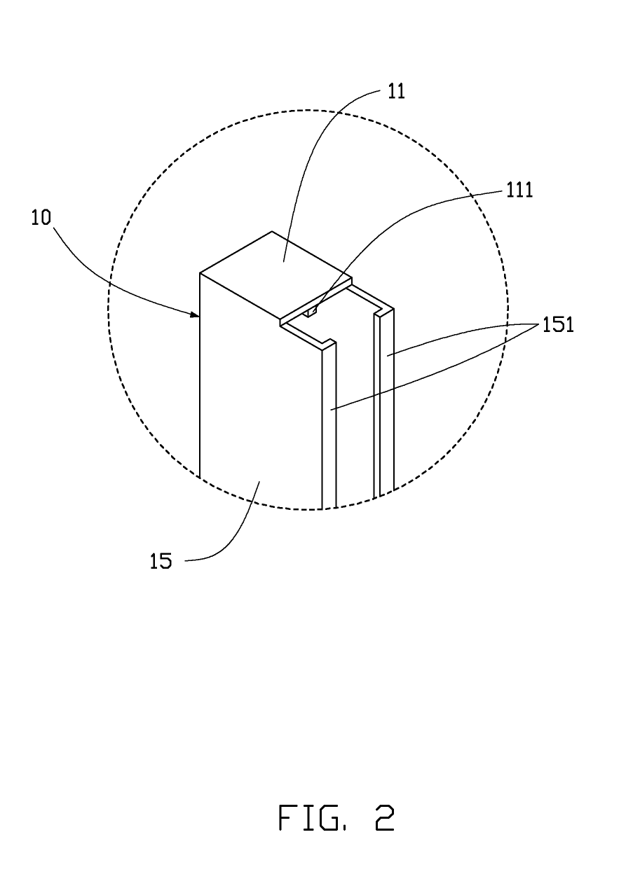

Referring to FIGS. 1-2, a mounting apparatus intended for securing an electronic device 80 according to one embodiment is shown. The electronic device 80 may be, for example, a desktop computer, a notebook computer, a digital camera, a mobile phone, or the like. The mounting apparatus in accordance with an embodiment includes a base 100, two supports 10, two positioning members 20, a securing member 30, and a plurality of operating members 50.

Each support 10 may be substantially hollow and secured to the base 100. The support 10 may be secured to the base 100 to a bottom wall 12 of support 10 by means for attaching such as screws; solder; or rivets.

Each support 10 may include an open side opposite to a first sidewall 13, a top wall 11, a bottom wall 12, and two second sidewalls 15. The open side of support 10 may be partially enclosed by flanges 151, which extend from the two second sidewalls 15. In one embodiment, the support 10 may be approximately a cuboid-shaped box with an opening side. In another embodiment, the flanges 151 are substantially perpendicular to the two second sidewalls 15 and parallel to the first sidewall 13.

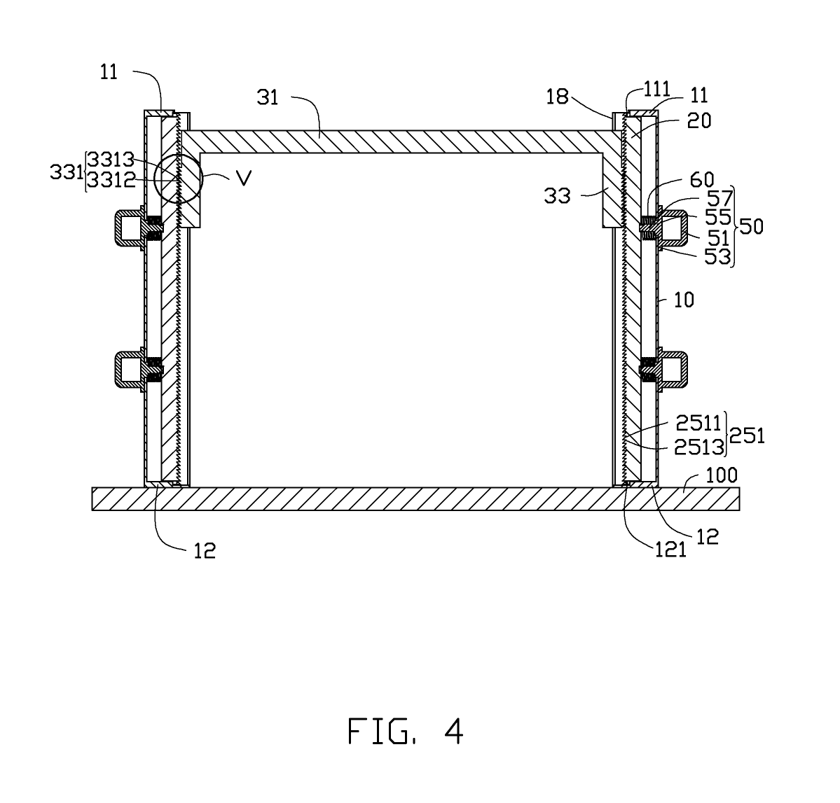

A first guide 111 is located on an inner surface of the top wall 11, and a second guide 121 (shown in FIG. 4) is located on an inner surface of the bottom wall 12. Two pieces 125 extend outward from the two opposites edges of the bottom wall 12, and are connected with the two second sidewalls 15. Two securing holes 1251 for securing the bottom wall 12 to the base 100 are defined in each of the two piece 125. A rib 16 connects each of the two piece 125 to each of the two second sidewalls 15. Two through holes 131 are defined in the first sidewall 13 of each support 10. In one embodiment, each through hole 131 is void

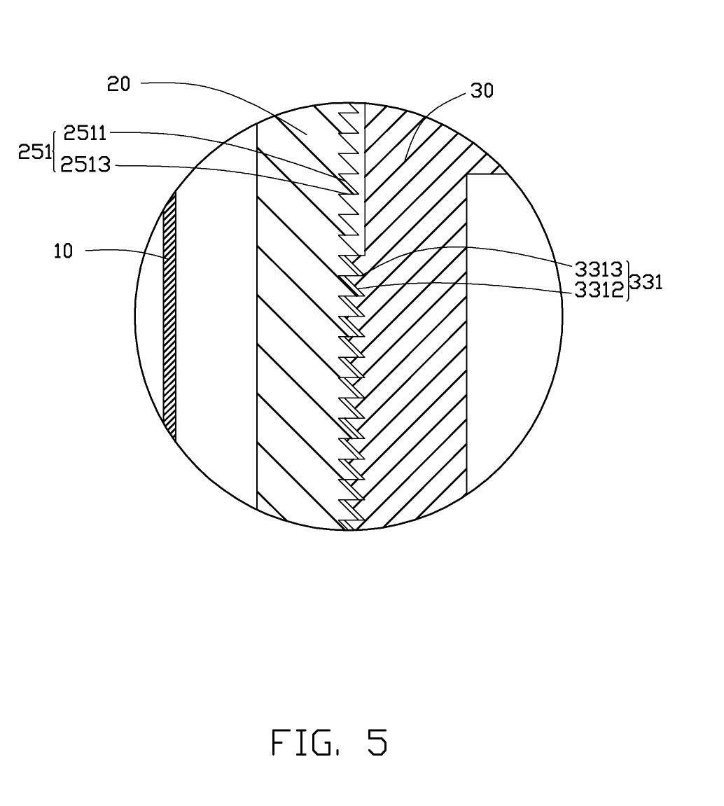

Each positioning member 20 is configured to be received between the top wall 11 and the bottom wall 12 and between the two second sidewalls 15. In one embodiment, a first slot 211 and a second slot 231 are defined on two opposite ends of the positioning member 20 so that the first slot 211 may slid against the first guide 111, and the second slot 231 against the second guide 121. One side of the positioning member 20, perpendicular to the two ends, has a tooth-shaped surface with a plurality of first teeth 251. Two mounting holes 253 are defined on the opposite side of the tooth-shaped side of the positioning member 20. Referring to FIG. 5, each of the plurality of first teeth 251 includes a guiding surface 2511, and a blocking surface 2513 connected with the guiding surface 2511 to form a triangle. In one embodiment, each of the plurality of first teeth 251 is an obtuse-angled triangle.

The securing member 30 includes a bar 31 and two securing portions 33 located at two opposite ends of the bar 31. A portion of surfaces facing away from the two ends of the bar 31, of the two securing portions 33, is tooth-shaped with a plurality of second teeth 331. In one embodiment, a slit 3331 is defined on each side perpendicular to the tooth-shaped side of each of the two securing portions 33. Each of the slit 3331 of the securing member 30 may slide against the flanges 151 of the two supports 10. Referring to FIG. 5, each of the plurality of second teeth 331 includes a second guiding surface 3312, and a second blocking surface 3313 connected with the second guiding surface 3312 to form a triangle. In one embodiment, each of the plurality of second teeth 331 is an obtuse angled triangle which slants towards the bar 31.

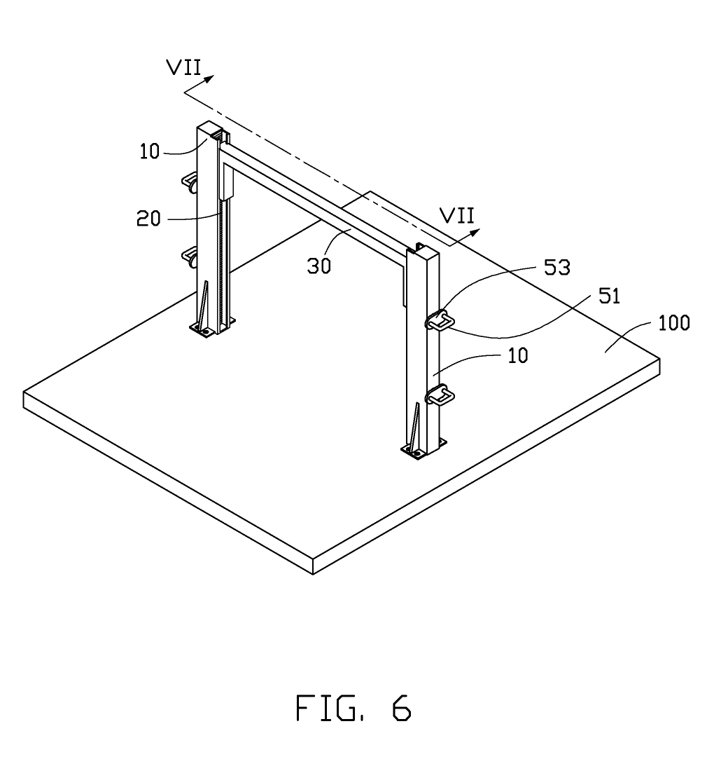

Referring to FIG. 6, each of the plurality of operating members 50 includes a main portion 53, an handgrip 51, and a mounting portion 57. The handgrip 51 and the mounting portion 57 are on opposite sides of the main portion 53. A positioning portion 55 is located on the mounting portion 57. In an embodiment, the cross-sectional shape of the positioning portion 55 is substantially the same as that of the through hole 131.

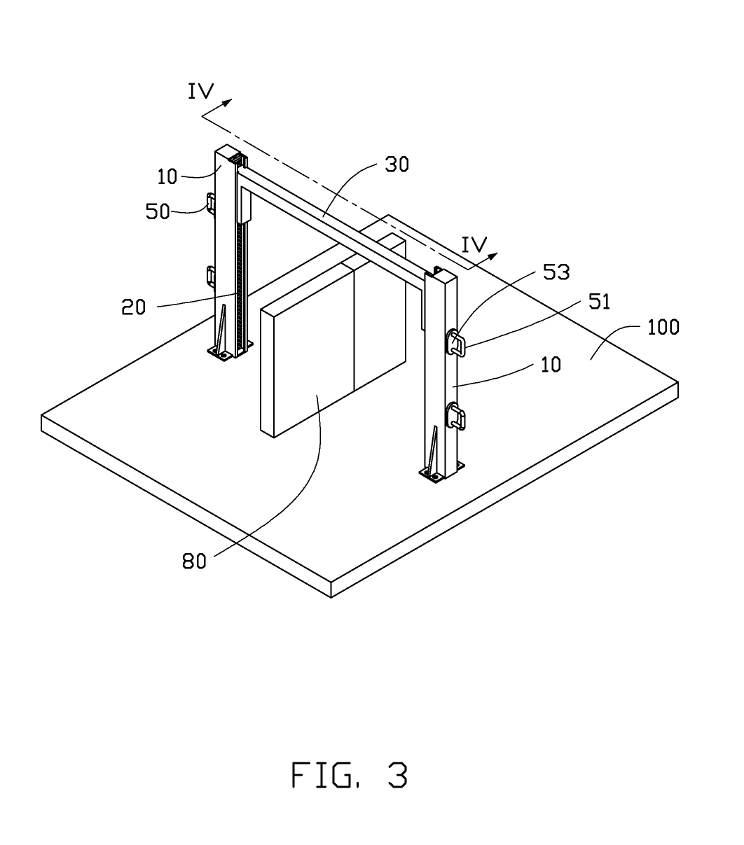

Referring also to FIGS. 3 to FIG. 7, in assembly, two resilient members 60 may be received between each of the two second sidewalls 15. In one embodiment, the resilient member 60 is a spring. One positioning member 20 may be placed in each of the two supports 10, between the two second sidewalls 15 with the plurality of first teeth 251 facing the flanges 151. The first slot 211 may slide into the first guide 111, and second slot 231 into the second guide 121. The two mounting holes 253 may be aligned with the two through holes 131. The two resilient members 60 may be located at the two through holes 131, between the first sidewall 13 of the support 10 and the positioning member 20. The positioning member 20 may be pushed to slide towards the first sidewall 13 by sliding the first guide 111 into the first slot 211, and the second guide 121 into the second slot 231. The two resilient members 60 are thus compressed. The mounting portions 57 of the operating members 50 may be engaged with the mounting holes 253 of the positioning members 20 through the through holes 131 and the resilient members 60.

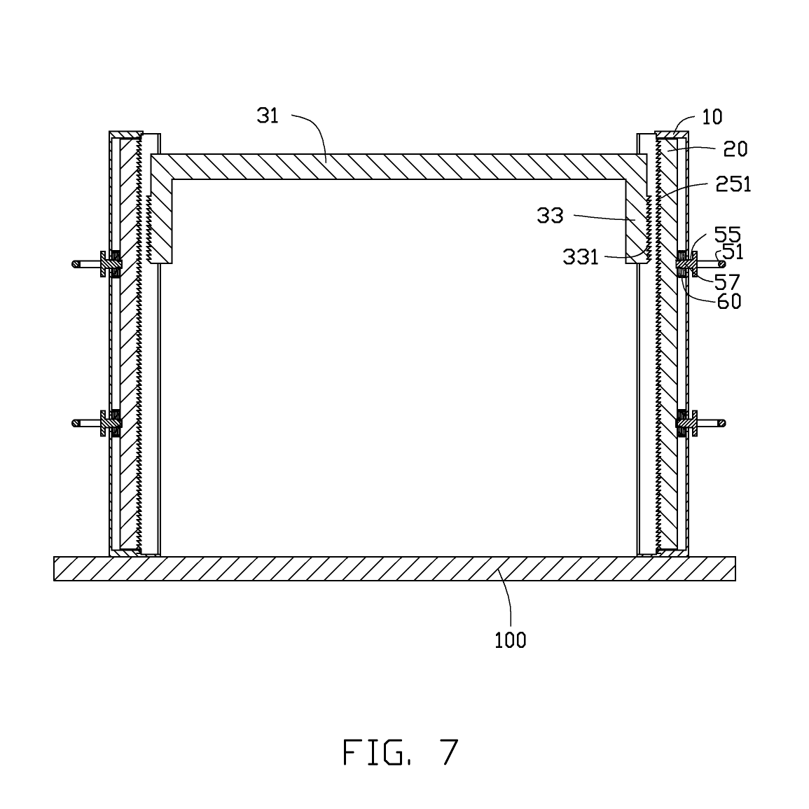

Each positioning member 20 may be slid between a first position (shown in FIGS. 3 and 4) and a second position (shown in FIGS. 6 and 7). In the first position, the plurality of second teeth 331 are engaged with the plurality of first teeth 251, the resilient member 60 has a first length, and the positioning portion 55 of the operating member 50 is engaged in the through hole 131. In the second position, the plurality of second teeth 331 are disengaged from the plurality of first teeth 251, the resilient member 60 is further compressed and has a second length which is less than the first length, and the positioning portion 55 of the operating member 50 is disengaged from the through hole 131. When the two positioning members 20 are slid from the second position to the first position, the two positioning members 20 are pushed towards the securing member 30. When the two positioning members 20 are slid from the first position to the second position, the two positioning members 20 are pulled away from the securing member 30. The operating members 50 may not be rotated when the two positioning members 20 are in the first position and the positioning portions 55 are engaged in the through holes 131. The operating members 50 may be rotated to abut an outer surface of the first sidewall 13 when the two positioning members 20 are in the second position. Each of the two positioning members 20 may be slid from the second to the first positions by the two resilient members 60 when the compressions on the two resilient members 60 are released.

Referring to FIG. 3, the assembly is in use with the electronic device 80 standing on the base 100 between the two supports 10. The two positioning members 20 are initially in the first position with the resilient members 60 in a released state. The securing member 30 is then placed onto the two supports 10 and pressed to slide towards the base 100 to hold down the device 80. When the second guiding surface 3312 of each of the plurality of second teeth 331 press against the first guiding surface 2511 of each of the plurality of first teeth 251, the two positioning members 20 are slid away from each other, towards the first sidewalls 13. The resilient members 60 are thereby compressed. When the second blocking surface 3313 of each of the plurality of second teeth 331 press against the first blocking surface 2513 of each of the plurality of first teeth 251, the resilient members 60 are partially released to allow some lateral movements along the first guide 111 and the second guide 121 of each of the two positioning members 20. In this fashion, the securing member 30 may be pushed to slide along the two positioning members 20 towards the base 100 until the electronic device 80 is securely held between the bar 31 and the base 100.

When the securing member 30 abuts the electronic device 80, the electronic device 80 is secured on the base 100. In one embodiment, the mounting apparatus is a test apparatus used in a drop test for the electronic device 80, and the base 100 is a test platform which may be allowed to fall together with the electronic device 80.

To remove the device 80 from the mounting apparatus, the operating members 50 may be pulled away from each other (away from the two position members 20) to guide the two positioning members 20 from the first position to the second position. The plurality of first teeth 251 are thereby disengaged from the plurality of second teeth 331, and the securing member 30 may be then removed from the two positioning members 20 to release the electronic device 80.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting apparatus comprising:
a base;
two supports secured to the base;
a positioning member located in each of the two supports, wherein the positioning member and each of the two supports are configured to move relative to each other along an axis parallel to a surface of the base, and the positioning member has a tooth-faced side with a plurality of first teeth;
a securing member having a plurality of second teeth, wherein the securing member is adapted to engage with the positioning member by meshing the plurality of second teeth and the plurality of first teeth, and the securing member is slidable towards the base along the positioning member; and
two resilient members located in each of the two supports, wherein the two resilient members maintains engagement between the plurality of first teeth and the plurality of second teeth.

2. The mounting apparatus of claim 1, wherein each of the two supports comprises a top wall and a bottom wall, a first guide located on the top wall of each of the two supports, and a second guide located on the bottom wall of each of the two supports; the positioning member defines a first slot and a second slot in opposite ends; and the first guide is engaged in the first slot, and the second guide is engaged in the second slot.

3. The mounting apparatus of claim 2, wherein each of the two supports further comprises a first sidewall, and the two resilient members are correspondingly located between the first sidewall and the positioning member.

4. The mounting apparatus of claim 3, wherein the first sidewall of each of the two supports is substantially perpendicularly connected to the top wall and the bottom wall.

5. The mounting apparatus of claim 2, wherein each of the two supports further comprises two second sidewalls substantially parallel to each other, and a flange extends from each of the two second sidewalls; and the securing member defines a plurality of slits configured to receive the flange.

6. The mounting apparatus of claim 5, wherein the two second sidewalls of each of the two supports are substantially perpendicularly connected to the top wall and the bottom wall.

7. The mounting apparatus of claim 3, further comprises through holes in the first sidewall of each of the two supports; and operating members capable of securing the positioning member through the through holes and sliding the positioning member along the first guide and the second guide.

8. The mounting apparatus of claim 7, each of the operating members comprises a main portion; a handgrip; and a mounting portion; wherein the handgrip and the mounting portion are located on opposite ends of the main portion, and the mounting portion is secured to the positioning member.

9. The mounting apparatus of claim 8, wherein each of the operating members further comprises a positioning portion located on the mounting portion, each of the operating members is prevented from rotating when the positioning portion is engaged in each of the through holes.

10. A mounting apparatus comprising:
a base;
two supports secured to the base;
a positioning member located in each of the two supports, wherein the positioning member and each of the two supports are configured to move relative to each other, and the positioning member has a tooth-faced side with a plurality of first teeth;
two operating members secured to the positioning member through each of the two supports;
a securing member comprising a plurality of second teeth, wherein the securing member is adapted to engage with the positioning member by meshing the plurality of second teeth and the plurality of first teeth, and the securing member is slidable towards the base along the positioning member; and
two resilient members located in each of the two supports,
wherein the positioning member is slidable between a first position, where the plurality of first teeth are engaged with the plurality of second teeth, and each of the two resilient members has a first length; and a second position, where the plurality of first teeth are disengaged from the plurality of second teeth, and each of the two resilient members is resiliently deformed and has a second length smaller than the first length, and wherein the two operating members are rotatable relative to each of the two supports when the positioning member is located in the second position.

11. The mounting apparatus of claim 10, wherein the positioning member and each of the two supports are configured to move relative to each other along an axis parallel to a surface of the base, and the securing member is capable of sliding in a direction substantially perpendicular to the surface of the base.

12. The mounting apparatus of claim 10, wherein each of the two supports comprises a top wall and a bottom wall; a first guide located on the top wall of each of the two supports; and
a second guide located on the bottom wall of each of the two supports, wherein the positioning member defines a first slot and a second slot in opposite ends, and the first guide is engaged in the first slot, and the second guide is engaged in the second slot.

13. The mounting apparatus of claim 12, wherein each of the two supports further comprises a first sidewall, and the two resilient members are correspondingly located between the first sidewall and the positioning member.

14. The mounting apparatus of claim 13, wherein the first sidewall of each of the two supports is substantially perpendicularly connected to the top wall and the bottom wall.

15. The mounting apparatus of claim 12, wherein each of the two supports further comprises two second sidewalls substantially parallel to each other; and a flange extends from each of the two second sidewalls, wherein the securing member defines a plurality of slits configured to receive the flange.

16. The mounting apparatus of claim 15, wherein the two second sidewalls of each of the two supports are substantially perpendicularly connected to the top wall and the bottom wall.

17. The mounting apparatus of claim 13, further comprises through holes in the first sidewall of each of the two supports; and an operating member that comprises a main portion, a handgrip and a mounting portion; wherein the handgrip and the mounting portion are located on opposite ends of the main portion, and the mounting portion is secured to the positioning member through each of the through holes.

18. The mounting apparatus of claim 17, the operating member further comprises a positioning portion located on the mounting portion, wherein the operating member is prevented from rotating when the positioning portion is engaged in each of the through holes.

19. The mounting apparatus of claim 18, wherein the positioning portion is engaged in each of the through holes when the positioning member is in the first position, and disengaged from each of the through holes when the positioning member is in the second position.

20. The mounting apparatus of claim 19, wherein the positioning portion is rotatable to abut on the first sidewall of each of the two supports to maintain the positioning member in the second position.
